(19) United States
(12) Patent Application Publication
(10) Pub. No.: US 2015/0092179 A1
(43) Pub. Date: Apr. 2, 2015

(54) LIGHT RANGING WITH MOVING SENSOR ARRAY

(71) Applicant: Izak Jan VAN CRUYNINGEN, Portola Valley, CA (US)

(72) Inventor: Izak Jan van Cruyningen, Portola Valley, CA (US)

(21) Appl. No.: 14/399,919

(22) PCT Filed: May 10, 2013
(86) PCT No.: PCT/US2013/040663

§ 371 Date: Nov. 7, 2014

Related U.S. Application Data
(60) Provisional application No. 61/646,284, filed on May 12, 2012.

(51) Int. Cl. G01S 17/08

(52) U.S. Cl. CPC G01S 17/08
USPC 356/4.01

(57) ABSTRACT

A light ranging device is mounted on a moveable platform, for example an airplane. The light ranging device may include an illumination source for providing a pulse of light, beam shaping optics to form a beam of light directed at a target, and collection optics for providing reflected light of the beam to a light-sensitive sensor array. A processor may determine range to the target based on spatial displacement of received light on the sensor array compared to expected position of the light due to platform movement.

### CROSS-REFERENCE TO RELATED APPLICATION

This application is a national phase filing, under 35 U.S.C. §371(c), of International Application No. PCT/US2013/040663, filed May 10, 2013, which claims the benefit of U.S. Provisional Application No. 61/646,284 filed on May 12, 2012, the disclosures of which are incorporated herein by reference in its entirety.

### BACKGROUND OF THE INVENTION

This invention relates generally to non-contact measurement of distances or ranges using time-of-flight measurement of reflected pulses of light, and more particularly to such measurements with conversion of temporal variation of the reflections to spatial variation across an array of detectors.

Different approaches to non-contact measurement of distances can be grouped into several major categories. Triangulation systems use a light source and detector (or two detectors for passive systems) separated by a baseline. The baseline and the paths of light form a triangle. Determination of an angle in the triangle and using the known baseline length defines the size of the triangle and thus the distance or range. For these systems the signal goes down as the square of the range and the measurement uncertainty goes up as the square of the range, so they are useful at short ranges. Commercial systems generally have less than ten meter ranges, with high precision. Larger baselines improve accuracy, but may cause shadows on surfaces with deep relief. Interferometer systems use the interference between two beams of light to very precisely determine differences in distance. They can precisely measure to within fractions of a wavelength, but suffer from range ambiguity and vibration sensitivity, making them difficult to use in the field.

Phase measurement techniques modulate (AM, FM) a continuous light source. They detect the reflection or echo of the modulated light and measure the phase difference to determine the distance. The measurement uncertainty depends on modulation frequency and usable range depends on ambiguity interval. High frequency modulation provides precision, but low frequency modulation provides a wider range without ambiguity. Using several modulation wavelengths or variable frequency chirps covers a larger range with good accuracy, but takes more time to measure. Phase measurement techniques can be precise, have a wide range, or be fast; but generally not all three. Time of flight systems send a pulse of light and measure the time for the reflection or echo to come back. Using the known speed of light, the distance can be calculated. This works for long ranges (kilometers or more with high energy lasers), with accuracy limited by the difficulty of measuring time intervals precisely to fractions of a nanosecond.

Scanner time-of-flight systems use mirrors to sweep the beam across the field of view, capturing the distance at one point for each pulse of light. An instrument mounted on a moving platform (satellite, aircraft, train, car, etc.) sweeps the beam in the transverse direction and uses the motion of the platform for the dimension along the path of travel. The point density of measurements is limited by the pulse repetition frequency (PRF) of the laser. The latest commercial systems use two lasers to increase the pulse rate to maximize the samples per unit area.

Terrestrial instruments scan in two dimensions, typically using a mirror rotating about a horizontal axis to scan the beam in the vertical direction; and rotating about a vertical axis to capture the full 360 degree angle. They capture a hemisphere of ranges from a single location. Mounting them on a moving platform, like a car, allows measurement of ranges to all points along the road visible from the car.

In scanner time-of-flight systems the illumination beam has a finite spot size, so there may be several reflectors in the beam producing multiple echoes. For example, with an airborne system over a forest, the canopy leaves, branches, understory plants, and ground may each produce echoes of part of the beam. At the edge of a building, both the roof and the ground will reflect some light producing multiple echoes. Some commercial systems record up to four echoes per laser pulse. Newer systems store the full return waveform and allow post processing to extract each individual reflection. Reflections from objects closer together than half the length of the light pulse are difficult to distinguish in range.

Problems with current implementations of scanned time-of-flight systems include:
difficulty of accurately timing to fractions of a nanosecond (timing jitter),
mass and mechanics of a moving mirror,
difficulty of producing lasers with both high energy pulses and high repetition rates,
high system cost, and
high laser energy in a collimated beam is a risk to eye safety.

### BRIEF SUMMARY OF THE INVENTION

Aspects of the various embodiments in accordance with aspects of the invention do not use timers or synchronization accurate to fractions of a nanosecond. Some embodiments in accordance with aspects of the invention capture an entire received reflected waveform, allowing analysis of multiple scattering objects in, for example, forestry applications; or the ability to “see through” fog, dust, vegetation, netting, or venetian blinds. Some embodiments in accordance with aspects of the invention capture an entire transverse line with a two-dimensional sensor array for each light pulse, substantially reducing the required pulse repetition frequency (PRF) compared with single beam scanner systems, within various embodiments. However the light energy is much less than for flash LiDAR systems because the energy is spread over a line rather than the entire angle of view. Some embodiments in accordance with aspects of the invention do not use rotating mirrors or scanners to scan along the line which minimizes the number of moving parts. This also allows much larger receiving optics to maximize received signal to noise. Some embodiments in accordance with aspects of the invention allow for use of standard off-the-shelf components throughout the system to minimize cost. Custom sensor arrays or custom fiber optic bundles are not necessary in various embodiments. Some embodiments in accordance with aspects of the invention the illumination source in various embodiments is any type of laser, LED, or light source that can produce short, bright pulses and be shaped into a sheet.

In some aspects the invention provides a light ranging system for measuring distances from a moving platform to a target, comprising: an illumination source couplable to a moveable platform, the illumination source capable of being pulsed to form a pulse of light to be directed towards said target; a light-sensitive sensor array; collection optics to image reflections of said light from said target onto a sensor array during movement of the platform, whereby position of said image on said sensor array corresponds to distance between said platform and said target. In some such aspects the system further comprises beam shaping optics to form the pulse of light from said illumination source into a sheet of light directed towards said target. In some such aspects the beam shaping optics are configured to form the sheet of light such that the sheet of light defining an axis transverse to a first direction, the first direction being a direction of movement of the platform. In some such aspects the system further comprises a range offset actuator for moving the illumination source and beam shaping optics in the first direction. In another such aspect the movement in first direction is a translational movement. In another such aspect the movement in the first direction is a rotational movement. In some such aspects the collection optics include a displacement magnifier to increase an effective spatial variation of imaged light on said sensor array. In some such aspects the system further comprises a depth of field adjuster for moving the displacement magnifier so as to alter spread of imaged light over said sensor array. In some such aspects the system further comprises an image intensifier in front of the sensor array. In some such aspects the system further comprises an array adjuster for adjusting position of the sensor array. In some such aspects the system further comprises a moveable platform. In some such aspects the system further comprises a zoom actuator coupled to the collection focusing optics.

In another aspect the invention provides a method useful in determining range from a moveable platform to an object, comprising: transmitting a pulse of a sheet of light from a light source towards a target; moving a platform carrying the light source and an array of sensors; receiving a reflection of the sheet of light from the target; and providing the received reflection of the sheet of light to the array of sensors. In some such aspects the invention provides the sheet of light is along an axis substantially transverse to a direction of movement of the platform. In some such aspects the platform is a vehicle. In another such aspect the method further comprises effectively increasing a spatial separation between an expected location of received light on the array of sensors for a non-moving platform and a location of received light on the array of sensors for the moving platform. In some such aspects movement of the platform is translational movement. In another such aspect movement of the platform is rotational movement. In another such aspect the pulse of light is provided by a laser. In some such aspects method further comprises shaping the pulse of light into a transmitted sheet of light. In another such aspect the method further comprises determining a range to an object reflecting the light based on pixels of the array of sensors which receive the received reflection of the sheet of light. In another such aspect the invention comprises determining a height of an object reflecting the light based on pixels of the array of sensors which receive the received reflection of the sheet of light.

In another aspect the invention provides a method of useful in determining range to an object, comprising: transmitting a pulse of a sheet of light from a moving platform, the sheet of light defining an axis substantially transverse to a direction of movement of the platform; receiving a reflection of the sheet of light by a sensor array coupled to the moving platform; and determining a range to at least one object providing the reflection of the sheet of light based on locations of pixels of the sensor array which receive the reflected light.

In another aspect the invention provides a light ranging system, comprising: means for generating a pulse of light directed at a target from a moveable platform; a sensor array coupled to the moveable platform; and means for collecting reflected light of the pulse of light onto the sensor array.

Other aspects will be apparent from a consideration of the drawings and ensuing description.

### BRIEF DESCRIPTION OF THE DRAWINGS

FIG. 1 is a perspective view of light ranging device mounted on an airborne platform.

FIG. 2 is a perspective view of light ranging device rotating to capture a hemisphere of ranges.

FIG. 3 is a sectional view of a light ranger through a fore-aft centerline.

### DETAILED DESCRIPTION

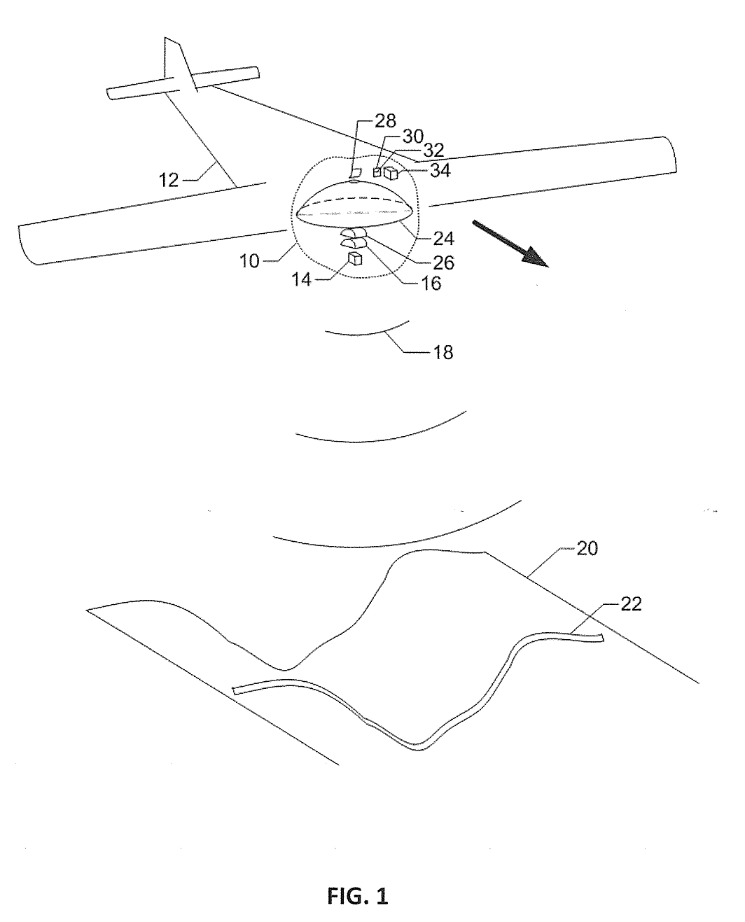

FIG. 1 is a perspective view of light ranging device 10 mounted on airborne platform 12. For convenience, at times herein the light ranging device may be referred to as a light ranger. The representation of airborne platform 12 is cut away to show light ranger 10 in more detail. Light from pulsed illumination source 14 is shaped by optics 16 into sheet of light 18 that propagates to a target 20. Light reflected from illuminated line 22 on target is collected by collection aperture 24 and focused by collection focusing optics 26 off displacement magnifier 28 onto sensor array 30 with the collection aperture, collection focusing optics, and displacement magnifier together providing an embodiment of what may be termed collection optics. An image on sensor array 32 is read out onto a processor 34, which may be configured, for example by program instructions or electronic circuitry to provide correction, a calculation, storage (for example in associated memory), or transmission (for example by way of associated transmission circuitry) functions.

Reflections from parts of illuminated line on target 22 that are closer to the light ranger 10 will arrive sooner than reflections from parts of target 20 that are further away. In most embodiments the platform 12 is moving while sheet of light 18 is propagating to target 20 and while reflections are propagating back to collection aperture 24. This temporal variation in reflected signals is converted into spatial variation by motion of platform 12, amplified by displacement magnifier 28, and recorded on sensor array 30. The processor 34 determines distance or range to all points in illuminated line on target 22 from one pulse of light. Sequential pulses allow the mapping of a swath over target 20 the width of illuminated line on target 22.

Temporal variations of reflections are “smeared out” into spatial variations by motion of platform 12. This is analogous (albeit at very different time scales) to motion blur in cameras. Aerial camera vendors may implement pitch control to keep a camera pointing at the same point on the ground during exposure to avoid motion blur. Digital camera vendors may develop image stabilization mechanisms to avoid motion blur in handheld cameras. Light ranger 10 magnifies motion blur in order to measure distances. Suppose airborne platform 12 is an airplane flying at 100 m/s at an altitude of 300 m. The time for a pulse to reach the ground and return is 2*300/300,000,000=2 microseconds. In that time the airplane will have moved 0.2 mm along the flight path.

If the airplane is flying over a redwood forest where the highest trees are 100 m tall then the reflections from the tops of the trees would return in 2*(300−100)/300,000,000=1.3 microseconds and the airplane will only have moved 0.13 mm before the first reflection returns. Thus the reflections from the tops of the trees, all the intermediate branches, and the ground are spread out over 0.2−0.13 mm=67 microns of airplane travel.

Commercial sensor arrays used in consumer camcorders and smart phones have a pixel pitch of ˜1.5 microns. If imaged directly, the 67 micron spatial variation corresponding to the 100 m “depth of field” of the forest would be spread over about 45 pixels, providing range resolution of about 2 m. Better range resolution is desirable and higher quality cameras tend to have larger pixels. The purpose of displacement magnifier 28 is to spread the 67 micron spatial variation over most of the height of a column of several hundred or thousand pixels in sensor array 30. This improves range resolution and allows the use of larger pixels. The full reflection waveform corresponding to one pixel's angle of view of illuminated line on target 22 is captured in a column on sensor array 30.

While light ranger 10 is based on time-of-flight of sheet of pulsed light 18 and its reflections, timers or synchronization mechanisms to sub-nanosecond timescales are not required to determine the distance from the airplane to the trees or ground. The geometry of the components in light ranger 10, the speed of light, and the velocity of light ranger 10 while the pulse and reflection are propagating are enough to determine the range to the target.

In many embodiments the approach does not require any moving mirrors or scanning pixels; simply the motion of light ranger 10. Light ranger 10 can be mounted on an airplane, model plane, satellite, car, train, robot, or any other moving platform.

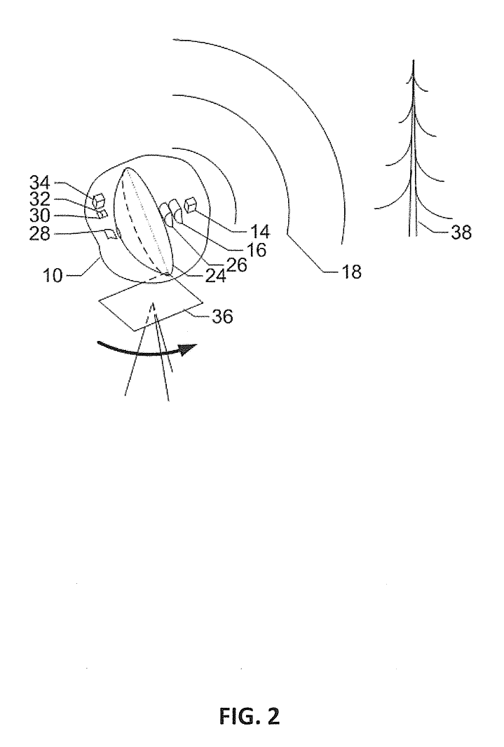

FIG. 2 shows light ranger 10 mounted on a rotating platform 36. Light from pulsed illumination source 14 passes through light shaping optics 16 to form a vertical sheet of pulsed light 18. Reflections from surfaces such as tree 38 are captured by collection aperture 24 and imaged through displacement magnifier 28 onto sensor array 30 by collection focusing optics 26. Image on sensor array 32 is corrected, processed, stored, and transmitted by processor 34.

While sheet of pulsed light 18 is propagating to tree 38 and the reflection propagates back to collection aperture 24, rotating platform 36 turns light ranger 10 through a small angle. This small angle is amplified by displacement magnifier 28 to provide a measurable spatial variation on sensor array 30. Knowing the speed of light, the angular velocity of rotating platform 36, and the optical geometry in light ranger 10, the range to different parts of vertical line on tree 38 can be calculated. Multiple pulses allow ranges to all targets in the hemisphere to be determined. The framing rate of sensor array 30 may not be enough to provide fine-grained angular resolution in one rotation. Multiple rotations may be used, determining range on a few vertical lines per rotation. Mounting the combination of light ranger 10 and rotating platform 36 on a moving platform such as a car or robot, allows surveying, collision avoidance, inspection, etc. along a road or path. Mounting this combination on an airplane or drone provides a mechanism to range other objects to help “sense and avoid” for autonomous flight.

Pulsed illumination source 14 in various embodiments can be a laser, LED, or other bright light source that can be shaped into a line on target 20. Using a narrowband source makes it easier to filter out background light with a spectral filter placed in front of sensor array 30. For exterior applications, this would improve contrast in daylight hours by filtering out light from the sun.

Illumination wavelengths may be chosen in the visible, ultraviolet, or infrared based on the reflectance of the target, quality of available light sources, and the sensitivity of sensor array 30. For example, in remote sensing, green vegetation absorbs blue and red visible light but reflects more than 50% of the near infrared light above the ‘red edge’ at ˜720 nm. An illumination source at a wavelength longer than 720 nm would make it easier to accurately detect vegetation. Laser diodes at 905 nm can provide high energy in nanosecond pulses and back-side illuminated silicon sensor arrays have about 20% quantum efficiency at 905 nm.

Using a laser diode at 1550 nm allows pulse energies four orders of magnitude higher for the same level of eye safety (the cornea does not focus 1550 nm light on the retina). However, SWIR sensor arrays that are sensitive to this wavelength are rare, have many fewer pixels than silicon-based sensors, and cost about three orders of magnitude more.

The length of the pulse determines whether two reflections from objects at almost the same range can be distinguished. A 5 nanosecond light pulse is 1.5 m long, so it would be difficult to distinguish objects closer together than 0.75 m. Q-switched lasers provide much shorter pulses. Passive Q-switched diode pumped solids state microlasers are available at high energy for reasonable cost. The 1064 nm wavelength is too high for many silicon sensor arrays, but at the frequency doubled 532 nm wavelength silicon detectors have high quantum efficiencies. A typical pulse length of 500 picoseconds is 15 cm long, so objects 7.5 cm apart can be readily distinguished if this light source is used.

Light shaping optics 16 in various embodiments can be cylindrical lenses, beam expanders, line generators, or other optics to form sheet of light 18 transverse to the direction of motion. FIG. 1 shows a very simple cylindrical mirror that works with pulsed laser diode sources.

These light sources generally have divergence angles of 7-9 degrees by 25-30 degrees. Placing a laser diode at the focal point of the cylindrical mirror, for example, allows formation of sheet of pulsed light 18. In the transverse direction, the naturally large divergence (7-30 degrees) of laser diodes creates the sheet width transverse to the direction of motion. In the other direction the pulse expands before it hits the mirror, and then collimates into a sheet diverging slowly near the diffraction limit. For the example of a light ranger on an airplane flying at 300 m, the illuminated line on target 22 would be about 65 m transverse by 6.5 cm parallel.

Expanding the beam as much as possible before it leaves light ranger 10 allows use of higher pulse energies without adding to eye safety risk.

FIGS. 1 and 2 show the collection optics collinear with the illumination optics. This is not necessary for this approach to work; in various embodiments the collection optics are offset from illumination optics. However a collinear approach has two advantages: 1) It makes it easier to align the two systems so they have the same angle of view independent of range. 2) It also maximizes the collection of reflected radiation. Most rough surfaces are not Lambertian reflectors; they have a distinct “hot spot” or anisotropic reflection angle. Reflection or backscatter to within a few degrees towards the illumination source is several times as strong as in other directions. Taking advantage of this “hot spot” or anisotropy will provide several times the signal for the same size collection aperture 24.

To maximize the signal to noise ratio, collection aperture 24 should be large. Regular lenses tend to be heavy and expensive at large diameters, so Fresnel lenses or concave mirrors are utilized in various embodiments. The solid angle of collection aperture 24 is orders of magnitude less than the total hemisphere. In the light ranger mounted on an airplane example described earlier, a 0.5 m diameter mirror at 300 m distance will collect 2×10⁻⁶ steradians out of a possible 2 pi steradians in the hemisphere. Doubling the diameter of the mirror will give four times the signal. A significant improvement over scanned time-of-flight systems is that this mirror does not have to scan, so it can be made large.

Collection optics are asymmetric in various embodiments. They act like a wide angle lens transverse to the direction of motion to match the width of illuminated line on target 22 and to maximize the swath width. However, they perform like a zoom lens or telescope parallel to the direction of motion to focus the thickness of illuminated line on target 22 onto a few pixels in sensor array 30. FIG. 1 shows a simple design much like a one dimensional Cassegrain telescope with a parabolic reflector for collection aperture 24 and a convex cylindrical lens of comparable focal length for collection optics.

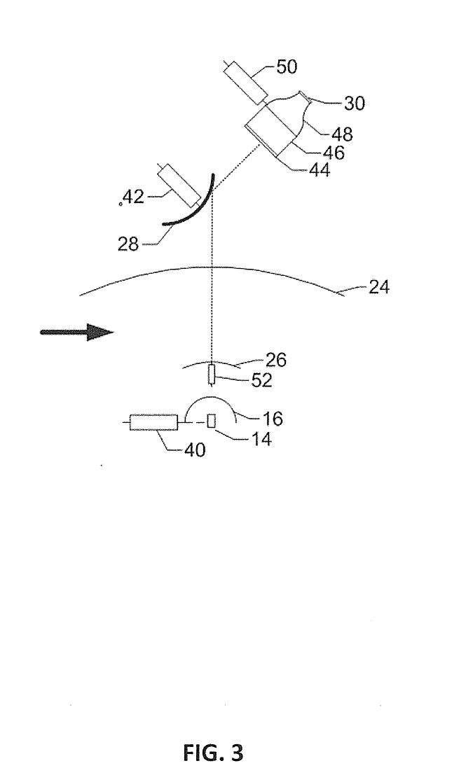

FIG. 3 is a section fore-aft through light ranger 10 showing additional optional details that enhance performance. Pulsed illumination source 14 and light shaping optics 16 are connected to range offset actuator 40. Collection aperture 24 and collection focusing optics 26 capture and focus reflections from target 20. Collection focusing optics 26 are connected to zoom actuator 52. Displacement magnifier 28, which may have a curved surface and which may be, as one of skill in the art would understand, for example mirror, is connected to depth of field adjuster 42. Spectral filter 44, image intensifier 46, and fiber bundle taper 48 are optional components placed in front of sensor array 30. These four components connect to array adjuster 50. Actuators 40, 42, 50, and 52 can be electrical, hydraulic, pneumatic, or, in some embodiments a mechanical screw that is adjusted during set-up for a particular ranging session.

For the forestry application described above, light ranger 10 may be mounted on an airplane flying at 300 m to measure a forest ranging in height from ground level to 100 m. By analogy to focusing lenses, one can say the desired “depth of field” is 100 m. Ideally the reflections from objects in this depth of field are spread over a large part of sensor array 30 to maximize the range resolution. To handle abrupt terrain elevation variations that the airplane cannot track quickly enough, the depth of field may be spread over 70-80% of the array, not the whole array.

A reflection from the middle of the 100 m depth of field would return in 1.67 microseconds during which time the airplane moves 0.167 mm. To keep the reflections as close as possible to the optical axis of collection aperture 24, range offset actuator 40 moves pulsed illumination source 14 and light shaping optics 16 forward in the direction of travel 0.167 mm. For this forestry scenario with low altitudes and moderate speeds, slight off-axis imaging will not produce too many aberrations. For aircraft flying at higher elevations or faster speeds, it is convenient to easily adjust the range offset with actuator 40. As an extreme example, for a satellite flying at 7300 m/s at an altitude of 700 km, the range offset would be 34 m forward to ensure the reflections hit collection aperture 24.

In forestry applications the depth of field is the tallest trees plus terrain variation ˜100 m, in urban environments the depth of field is height of the tallest buildings ˜400 m, and in a satellite application the depth of field may be ˜9,000 m to match the height of Mt. Everest, depending on a desired aspect to be measured. For the terrestrial mount shown in FIG. 2 the depth of field would be tens of meters for interior applications and hundreds of meters outside. An adjustable depth of field makes it easier to support all these different scenarios. Depth of field adjuster 42 moves displacement magnifier 28 to alter the spread the reflections over sensor array 30. Array adjuster 50 moves spectral filter 44, image intensifier 46, fiber optic taper 48, and sensor array 30 to capture the reflections. If displacement magnifier 28 is a cylindrical mirror with constant radius, then the depth of field can be adjusted over little more than an order of magnitude. Using a decreasing radius mirror provides a larger adjustment of the depth of field. Some alternatives for magnifying the depth of field are lenses and prisms.

With a curved displacement magnifier 28 the depth of field resolution may not be constant with pixel pitch, i.e. in the near field one pixel separation may correspond to 20 cm, while in the far field one pixel may correspond to 10 cm. The geometric relationship would be known and unchanging and may be corrected in post-processing by correction, calculation, storage, and transmission processor 34. This nonlinear relationship could be used to advantage. For example, in a dense tropical forest only about 2% of incident light reaches the ground. Using high resolution for the far field for the occasional ground measurement points at the expense of lower resolution for the large number of canopy reflections provides a more useful overall measurement.

Automating range offset actuator 40, depth of field adjuster 42, array adjuster 50, and zoom actuator 50 with feedback loops from correction, calculation, storage, and transmission processor 34 allows zooming in on a target of interest. Start with the depth of field at the maximum detectable range and zoom set for wide angle viewing. When an object is detected, adjust the actuators to narrower depths of field and narrower angles of view until they just encompass the object of interest with maximum resolution. Adding another actuator on light shaping optics 16 would allow adjustment of sheet of pulsed light 18 to focus more of the light energy on the target to maximize the signal.

Spectral filter 44 is useful if pulsed illumination source 14 has a narrow spectrum. Spectral filter 44 rejects ambient light to improve the contrast and signal to noise ratio of the signal on sensor array 30.

At the limit of ranging distance, the number of reflected photons collected by collection aperture 24 may become too small and the noise in sensor array 30 may exceed the signal. Image intensifier 46 can produce photon gains of four orders of magnitude, thereby extending the range of the system significantly. Image intensifiers may not be useful in systems where times of flight are measured with timers because the phosphor decay times are tens of microseconds. However for light ranger 10, the temporal variation is transformed to spatial variation, so image intensifiers can be used.

For small sensor arrays 30 it may be difficult to design optics to produce a large angle of view. Fiber optic taper 48 allows magnifications of two to three times with a transmittance of 10-40%. Placing a taper on a small sensor makes it much easier to design collection optics with a wide angle of view. If image intensifier 46 is used, fiber optic taper 48 is an efficient way to transmit light to array sensor 30.

After each pulse, array sensor 30 has an image of the reflections of illuminated line on target 22. Each pixel in a row corresponds to a different location in illuminated line on target 22, so the row pixel pitch determines the transverse resolution on the target. Each column has images of one or more reflections depending where the target(s) are in the depth of field. The column pixel pitch determines the depth resolution. If the pulse from illumination source 14 is not short enough, a reflection may be spread over several pixels in a column. The values of all the pixels in sensor array 30 have to be read out for further processing and storage before the next light pulse. The framing rate of sensor array 30 determines the resolution along the direction of motion (as long as pulsed illumination source 14 can be pulsed that quickly).

At the limits of ranging it may be beneficial to narrow the width of sheet of pulsed light 18 to concentrate the illumination energy into a smaller area on the target. Taken to the limit, sheet 18 becomes a single beam and sensor array 30 only needs one column of pixels. This column of pixels replaces the photodiode and timing circuitry in existing scanned time-of-flight systems.

After image on sensor array 32 is read from sensor array 30 to correction, calculation, storage, and transmission processor 34, the image preferably is corrected before ranges are calculated. Some potential corrections are:
When measuring terrain elevation as in FIG. 1, the path length for the same elevation at angles off nadir is longer by the cosine of the angle.
Pulsed illumination source 14 may have spatial variations in energy that are corrected before comparing pulse magnitudes.
When displacement magnifier 28 has a curved surface the range resolution will vary over the depth of field.
When collection aperture 24 is large so the system F# is low, the collection optics will introduce aberrations that may be corrected.
When the time-of-flight becomes large for long ranges, then the velocity of the platform may not be constant over the duration of the pulse sending and receiving. The embodiment shown in FIG. 1 could include differential geographic position system (GPS) and/or an inertial measurement unit (IMU) sensors to correct for changes in velocity. The embodiment shown in FIG. 2 could use shaft encoders to determine angular position accurately.

Corrections and range determination can be done immediately after acquisition or in post processing. Immediate calculation utilizes more processing power in light ranger 10, but reduces storage and transmission volumes substantially. Instead of storing all the values in each column, the processor 34 would fit the pulse shape to each reflection in the column and then store the centerline, width, and height of the reflection. Since most columns would contain only one or two reflections, this substantially reduces the amount of data.

This section illustrated details of specific embodiments, but persons skilled in the art can readily make modifications and changes that are still within the scope.

1. A light ranging system for measuring distances from a moving platform to a target, comprising:
an illumination source couplable to a moveable platform, the illumination source capable of being pulsed to form a pulse of light to be directed towards said target;
a light-sensitive sensor array;
collection optics to image reflections of said light from a target onto said sensor array during movement of the platform, whereby position of said image on said sensor array corresponds to distance between said platform and said target.

2. The light ranging system of claim 1, further comprising beam shaping optics to form the pulse of light from said illumination source into a sheet of light directed towards said target.

3. The light ranging system of claim 2, wherein the beam shaping optics are configured to form the sheet of light such that the sheet of light defining an axis transverse to a first direction, the first direction being a direction of movement of the platform.

4. The light ranging system of claim 3, further comprising a range offset actuator for moving the illumination source and beam shaping optics in the first direction.

5. The light ranging system of claim 3, wherein the movement in first direction is a translational movement.

6. The light ranging system of claim 3, wherein the movement in the first direction is a rotational movement.

7. The light ranging system of claim 1, wherein the collection optics include a displacement magnifier to increase an effective spatial variation of imaged light on said sensor array.

8. The light ranging system of claim 5, further comprising a depth of field adjuster for moving the displacement magnifier so as to alter spread of imaged light over said sensor array.

9. The light ranging system of claim 1, further comprising an image intensifier in front of the sensor array.

10. The light ranging system of claim 1, further comprising an array adjuster for adjusting position of the sensor array.

11. (canceled)

12. The light ranging system of claim 1, further comprising a zoom actuator coupled to the collection focusing optics.

13. A method useful in determining range from a moveable platform to an object, comprising:
transmitting a pulse of a sheet of light from a light source towards a target;
moving a platform carrying the light source and an array of sensors;
receiving a reflection of the sheet of light from the target; and
providing the received reflection of the sheet of light to the array of sensors.

14. The method of claim 13, wherein the sheet of light is along an axis substantially transverse to a direction of movement of the platform.

15. (canceled)

16. The method of claim 13, further comprising effectively increasing a spatial separation between an expected location of received light on the array of sensors for a non-moving platform and a location of received light on the array of sensors for the moving platform.

17. The method of claim 13, wherein movement of the platform is translational movement.

18. The method of claim 13, wherein movement of the platform is rotational movement.

19. The method of claim 13, wherein the pulse of light is provided by a laser.

20. The method of claim 13, further comprising shaping the pulse of light into a transmitted sheet of light.

21. The method of claim 13, further comprising determining a range to an object reflecting the light based on pixels of the array of sensors which receive the received reflection of the sheet of light.

22. (canceled)

23. A method of useful in determining range to an object, comprising:
transmitting a pulse of a sheet of light from a moving platform, the sheet of light defining an axis substantially transverse to a direction of movement of the platform;
receiving a reflection of the sheet of light by a sensor array coupled to the moving platform; and
determining a range to at least one object providing the reflection of the sheet of light based on locations of pixels of the sensor array which receive the reflected light.

24. (canceled)
